(19) United States
(12) Patent Application Publication
(10) Pub. No.: US 2007/0009641 A1
(43) Pub. Date: Jan. 11, 2007

(54) Stable tea concentrates

(76) Inventor: Ken R. Erickson, Dublin, OH (US)

Correspondence Address: Bell, Boyd & Lloyd LLC, P.O. Box 1135, Chicago, IL, 60690-1135, US

(21) Appl. No.: 11/177,705

(22) Filed: Jul. 8, 2005

(51) Int. Cl. A23F 3/00

(52) U.S. Cl. 426/597

(57) ABSTRACT

Stable tea concentrates are presented. In an embodiment, the tea concentrate comprises a solution having tea solids ranging from about 10% to about 35% by weight: a stabilizing agent ranging from about 30% to about 70% by weight; and water ranging from about 15% to about 35% by weight, wherein the tea solids, stabilizing agent and water are each added in amounts such that the tea solids do not precipitate out of the solution.

### BACKGROUND OF THE INVENTION

The present invention relates generally to beverages. More specifically, the present invention relates to tea concentrates for producing consumable beverages and methods of making the tea concentrates.

Stable tea concentrates are highly desirable and can be used in a variety of applications such as ready-to-drink tea products, tea concentrate products for retail sale; and tea concentrate products for use with dispensing devices. Generally, tea concentrates produce a final tea beverage with higher quality taste characteristics than that of a tea powder or a dilute tea extract. A tea concentrate can reduce sanitation issues associated with a powder-based product. In addition, a stable tea concentrate could be transported and stored without refrigeration, while maintaining micro and tea solids stability.

Many conventional tea concentrates are physically unstable or not pumpable, which prevents their use in many tea products. For example, tea solids have a tendency to precipitate out of solution thereby producing a beverage that is aesthetically undesirable in taste and appearance for a consumer. Further, tea concentrates that are too viscous are not easily pumpable and cannot readily be used in dispensing machines.

Therefore, there is a need to provide improved tea concentrates that are stable, pumpable and may be stored at ambient temperatures for long periods of time.

### SUMMARY OF THE INVENTION

The present invention provides stable beverage concentrates. In an embodiment, the present invention provides a beverage concentrate comprising a solution having tea solids ranging from about 10% to about 35% by weight; a stabilizing agent ranging from about 30% to about 70% by weight; and water ranging from about 15% to about 35% by weight, wherein the tea solids, stabilizing agent and water are each added in amounts such that the tea solids do not precipitate out of the solution.

In an embodiment, the beverage concentrate comprises at least one buffer salt ranging from about 0.01% to about 2.0%.

In an embodiment, the stabilizing agent is selected from the group consisting of sucrose, fructose, corn syrup, maltodextrin, dextrose, lactose, propylene glycol and combinations thereof.

In an embodiment, the solution comprises a solids content between about 60% to about 90% by weight.

In an embodiment, the solution comprises a water activity between about 0.75 to about 0.85.

In an embodiment, the solution is degassed.

In an embodiment, the beverage concentrate is free of preservatives.

In an embodiment, the solution is pasteurized.

In an embodiment, the tea solids range from about 15% to about 30% by weight.

In an embodiment, the stabilizing agent ranges from about 40% to about 60% by weight.

In an embodiment, the water ranges from about 20% to about 30% by weight.

In another embodiment, the present invention provides a stable tea concentrate comprising a solution having tea solids ranging from about 10% to about 35% by weight; one or more stabilizing agents ranging from about 30% to about 70% by weight; a buffer salt ranging from about 0.01% to about 2.0%; and water ranging from about 15% to about 35% by weight, wherein the tea solids, stabilizing agent, water and buffer salt are each added in amounts such that the tea solids do not precipitate out of the solution.

In another embodiment, the present invention provides a method of producing a stable tea concentrate, the method comprising combining tea solids ranging from about 10% to about 35% by weight with a stabilizing agent ranging from about 30% to about 70% by weight and water ranging from about 15% to about 35% by weight to form a solution, wherein the tea solids, stabilizing agent and water are each added in amounts such that the tea solids do not precipitate out of the solution.

In another embodiment, the present invention provides a beverage product comprising a tea aroma and a beverage concentrate comprising a solution having tea solids ranging from about 10% to about 35% by weight; a stabilizing agent ranging from about 30% to about 70% by weight; and water ranging from about 15% to about 35% by weight, wherein the tea solids, stabilizing agent and water are each added in amounts such that the tea solids do not precipitate out of the solution, and wherein the tea aroma is combined with the beverage concentrate to form the beverage product prior to consumption.

In another embodiment, the present invention provides a beverage concentrate comprising a solution having tea solids ranging from about 10% to about 35% by weight; a stabilizing agent ranging from about 30% to about 70% by weight; and concentrated tea aroma ranging from about 15% to about 35% by weight, wherein the tea solids, stabilizing agent and concentrated tea aroma are each added in amounts such that the tea solids do not precipitate out of the solution.

An advantage of the present invention is to provide an improved tea concentrate that is stable and pumpable.

Another advantage of the present invention is to provide an improved tea concentrate that may be stored at ambient temperatures for long periods of time.

Yet another advantage of the present invention is to provide an improved tea concentrate that does not require preservatives to be stored for long periods of time.

Additional features and advantages of the present invention are described in, and will be apparent from, the following Detailed Description of the Invention.

### DETAILED DESCRIPTION OF THE INVENTION

The present invention generally relates to beverage concentrates and methods of making same. In an embodiment, the present invention provides stable and pumpable tea beverage concentrates. The tea concentrates can be preservative free and still be stored at ambient temperatures for long periods of time. Stable, as used in the present specification, refers to the ability to inhibit pathogenic microbiological growth and/or the ability to prevent the tea solids from precipitating out of solution.

In the present specification, the term “concentrate” should be understood as a product derived from one or more extracts, e.g. such as tea, which can be diluted with a liquid such as water to form a drinkable beverage. In an embodiment, the tea concentrates may comprise from about 10% to about 35% tea solids. Preferably, tea concentrates comprise from about 15% to about 30% by weight tea solids.

In the present specification, the term “tea beverage” should be understood as a drinkable beverage prepared from the tea concentrates by dilution with any suitable liquid such as water. The tea concentrates can be diluted with any suitable amount of water or other liquids to provide the tea beverage. The liquids can be hot, cold or ambient temperatures. Preferably, the tea concentrates can be diluted to a minimum of about 0.1% to about 0.4% tea solids to provide the final tea beverage.

In the present specification, the term “tea solids” should be understood as solids present in a tea extract. Polyphenolic compounds (e.g. tannins) are normally the primary component of tea solids. However, it should be appreciated that tea solids can also include caffeine, proteins, amino acids, minerals, carbohydrates and other compounds derived from teas. It should also be noted that preventing tea solids from precipitating out of solution does not mean preventing a minute or an insignificant individual amount of tea solids from precipitating out of solution. For example, a minute or insignificant amount of tea solids precipitating out of solution may be an amount that does not adversely affect the overall taste or appearance qualities of the stable tea concentrate.

In the present specification, the term “stabilizing agent” should be understood to be any suitable agent capable of controlling the water activity and preventing the tea solids from precipitating out of solution. The stabilizing agents can be, for example, sucrose, fructose, corn syrup, maltodextrin, dextrose, lactose, propylene glycol or combinations thereof. Preferably, stabilizing agents do not include chemical preservatives.

In a solution of tea solids and water, the tea solids generally do not precipitate out of solution below 0.5% by weight or above 50% by weight tea solids. However, between 0.5% and 50% by weight, the tea solids will usually precipitate out of solution without any additional modifications to the solution. It was surprisingly found that a stable tea concentrate having a tea solids concentration between about 10% to about 35% by weight (i.e. middle ground of where tea solids normally precipitate), whereby the tea solids do not precipitate out of solution, could be produced.

In an embodiment, the stable tea concentrate can be produced by combining tea heavy liquor or tea powder with a stabilizing agent and water. The tea solids can range between about 10% to about 35% by weight, preferably from about 15% to about 30% by weight. The stabilizing agent can range between about 30% to about 70% by weight, preferably from about 40% to about 60% by weight. The water can range between about 15% to about 35% by weight, preferably from about 20% to about 30% by weight. In an embodiment, the stable tea concentrate can include buffer salts ranging between about 0.01% to about 2.0% by weight, preferably from about 0.1% to about 2.0%. The buffer salts can be any suitable salt such as, for example, sodium phosphate, disodium phosphate, potassium phosphate, dipotassium phosphate, sodium polyphosphate, sodium hexametaphosphate, sodium citrate, disodium citrate, potassium citrate and dipotassium citrate.

In an embodiment, the total solids content of the tea concentrate should range between about 60% to about 90% by weight, preferably from about 70% to about 80% by weight, and the water activity of the tea concentrate should range between about 0.70 to about 0.85, preferably from about 0.78 to about 0.84, to prevent the tea solids (e.g. having a range between 10% to 35%) from precipitating out of solution.

In another embodiment, the beverage concentrate comprises a solution having tea solids ranging from about 10% to about 35% by weight; a stabilizing agent ranging from about 30% to about 70% by weight; and concentrated tea aroma ranging from about 15% to about 35% by weight, wherein the tea solids, stabilizing agent and concentrated tea aroma (i.e. tea distillate) are each added in amounts such that the tea solids do not precipitate out of the solution.

In an alternative embodiment, a beverage product comprises the tea aroma or tea distillate and the beverage concentrate. The beverage concentrate is initially stored separately from the tea aroma. The beverage concentrate may comprise a solution having tea solids ranging from about 10% to about 35% by weight; a stabilizing agent ranging from about 30% to about 70% by weight; and water ranging from about 15% to about 35% by weight. The tea solids, stabilizing agent and water are each added in amounts such that the tea solids do not precipitate out of the solution. The tea aroma or tea distillate can be combined with the beverage concentrate to form the beverage product at any time prior (e.g. immediately prior to) to consumption by a consumer. The beverage product may comprise additional liquids such as water to give the beverage product a suitable taste preferred by the consumer.

By way of example and not limitation, the following Tables are illustrative of various embodiments of the present invention and further illustrate experimental testing conducted in accordance with embodiments of the present invention.

TABLE 1

| | Sugar | | | | aw | | |
|---|---|---|---|---|---|---|---|
| | Solids | | | | (should | | |
| Tea | (stabilizing | Total | | | remain | Tea solids | Dilution Ratio |
| Solids | agent) | Solids | Viscosity (cP) | | below | precipitate | (dispensed tea |
| (%) | (%) | (%) | @ 20° C. | @ 30° C. | 0.850) | (y/n) | conc. 0.176%) |
| 28.0% | 44.0% | 72.0% | 8,000 | 3,500 | 0.841 | no | 159:1 |
| 25.0% | 47.0% | 72.0% | 5,800 | 2,700 | 0.820 | no | 142:1 |
| 22.5% | 50.0% | 72.5% | 6,000 | 2,700 | 0.825 | yes | 128:1 |
| 20.0% | 52.0% | 72.0% | 3,100 | 1,400 | 0.837 | yes | 114:1 |
| 18.5% | 54.0% | 72.5% | 3,300 | 1,600 | 0.828 | yes | 105:1 |

TABLE 2

| | Sugar | | | | aw | | |
|---|---|---|---|---|---|---|---|
| | Solids | | | | (should | | |
| Tea | (stabilizing | Total | | | remain | Tea solids | Dilution Ratio |
| Solids | agent) | Solids | Viscosity (cP) | | below | precipitate | (dispensed tea |
| (%) | (%) | (%) | @ 20° C. | @ 30° C. | 0.850) | (y/n) | conc. 0.176%) |
| 26.0% | 48.0% | 74.0% | unmeasurable | 5,200 | 0.821 | no | 148:1 |
| 25.0% | 49.1% | 74.1% | not measured | 4,000 | 0.793 | no | 142:1 |
| 25.0% | 48.6% | 73.6% | not measured | 3,800 | 0.798 | no | 142:1 |
| 22.0% | 51.5% | 73.5% | 6,700 | 2,900 | 0.818 | yes | 125:1 |

In varying experiments, it appeared that sucrose provided the best stability at the lowest viscosity with no tea solids precipitation. However, there is a balance between the tea stability, water activity and viscosity to prevent the tea solids from precipitating. A change in one of the ingredient variables (e.g. tea solids, stabilizing agent, water) from a final stable tea concentrate formulation could cause a change in precipitation or viscosity of the solution. For example, when preparing the tea concentrate a 1% drop in tea solids from a final tea concentrate formulation could cause the tea solids to precipitate or a 1% increase in tea solids from a final tea concentrate formulation could cause the solution to exceed the viscosity limits.

The tea concentrate may be degassed to remove trapped air and to increase the solution density. The gas may be removed to prevent subsequent oxidation of the tea solids. The tea concentrate may also be pasteurized to kill all vegetative microorganisms. The tea concentrate can be filled aseptically (e.g. Intasept pouch filler) or clean filled (e.g. Scholle pouch filler) into pouches that can be used, for example, in a dispensing machines equipped to handle such concentrates.

In an example of generating a tea beverage using the stable tea concentrate, a targeted dispensing strength of the tea concentrate with diluting water from a dispensing machine can be about 0.176% tea solids when the diluting water and tea concentrate are mixed together and dispensed into a container having ice. The dilution ratio (e.g. water:concentrate) for this type of dispensing machine can range from 100:1-150:1. This means the tea concentrate should initially contain about 17.6% to about 26.4% tea solids. The concentration of tea solids in the final iced beverage container may be, for example, about 0.16%.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A beverage concentrate comprising a solution having
tea solids ranging from about 10% to about 35% by weight;
a stabilizing agent ranging from about 30% to about 70% by weight; and
water ranging from about 15% to about 35% by weight, wherein the tea solids, stabilizing agent and water are each added in amounts such that the tea solids do not precipitate out of the solution.

2. The beverage concentrate of claim 1 comprising at least one buffer salt ranging from about 0.01% to about 2.0%.

3. The beverage concentrate of claim 2, wherein the buffer salt is selected from the group consisting of sodium phosphate, disodium phosphate, potassium phosphate, dipotassium phosphate, sodium polyphosphate, sodium hexametaphosphate, sodium citrate, disodium citrate, potassium citrate and dipotassium citrate and combinations thereof.

4. The beverage concentrate of claim 1, wherein the stabilizing agent is selected from the group consisting of sucrose, fructose, corn syrup, maltodextrin, dextrose, lactose, propylene glycol and combinations thereof.

5. The beverage concentrate of claim 1, wherein the solution comprises a solids content between about 60% to about 90% by weight.

6. The beverage concentrate of claim 1, wherein the solution comprises a water activity between about 0.75 to about 0.85.

7. The beverage concentrate of claim 1, wherein the solution is degassed.

8. The beverage concentrate of claim 1, wherein the beverage concentrate is free of preservatives.

9. The beverage concentrate of claim 1, wherein the solution is pasteurized.

10. The beverage concentrate of claim 1, wherein the tea solids range from about 15% to about 30% by weight.

11. The beverage concentrate of claim 1, wherein the stabilizing agent ranges from about 40% to about 60% by weight.

12. The beverage concentrate of claim 1, wherein the water ranges from about 20% to about 30% by weight.

13. A stable tea concentrate comprising a solution having
tea solids ranging from about 10% to about 35% by weight;
sucrose ranging from about 30% to about 70% by weight;
a buffer salt ranging from about 0.01% to about 2.0%; and
water ranging from about 15% to about 35% by weight.

14. The beverage concentrate of claim 13, wherein the solution comprises a solids content between about 60% to about 90% by weight.

15. The beverage concentrate of claim 13, wherein the solution comprises a water activity between about 0.75 to about 0.85.

16. The beverage concentrate of claim 13, wherein the beverage concentrate is free of preservatives.

17. A method of producing a stable tea concentrate, the method comprising combining tea solids ranging from about 10% to about 35% by weight with a stabilizing agent ranging from about 30% to about 70% by weight and water ranging from about 15% to about 35% by weight to form a solution, wherein the tea solids, stabilizing agent and water are each added in amounts such that the tea solids do not precipitate out of the solution.

18. The method of claim 19 comprising adding at least one buffer salt ranging from about 0.01% to about 2.0% into the solution, wherein the tea solids, stabilizing agent, water and buffer salt are each added in amounts such that the tea solids do not precipitate out of the solution.

19. A beverage product comprising a tea aroma and a beverage concentrate comprising a solution having tea solids ranging from about 10% to about 35% by weight; a stabilizing agent ranging from about 30% to about 70% by weight; and water ranging from about 15% to about 35% by weight, wherein the tea solids, stabilizing agent and water are each added in amounts such that the tea solids do not precipitate out of the solution, and wherein the tea aroma is stored separately from the beverage concentrate and is combined with the beverage concentrate to form the beverage product prior to consumption.

20. A beverage concentrate comprising a solution having
tea solids ranging from about 10% to about 35% by weight;
a stabilizing agent ranging from about 30% to about 70% by weight; and
concentrated tea aroma ranging from about 15% to about 35% by weight, wherein the tea solids, stabilizing agent and concentrated tea aroma are each added in amounts such that the tea solids do not precipitate out of the solution.
